(19) United States
(12) Patent Application Publication
(10) Pub. No.: US 2003/0093787 A1
(43) Pub. Date: May 15, 2003

(54) Distribution system

(76) Inventor: Saim Gures Simsek, Uithoorn (NL)

Correspondence Address: PEACOCK MYERS AND ADAMS P C, P O BOX 26927, ALBUQUERQUE, NM, 871256927

(21) Appl. No.: 10/278,403

(22) Filed: Oct. 23, 2002

Related U.S. Application Data
(63) Continuation of application No. PCT/NL01/00312, filed on Apr. 19, 2001.

(30) Foreign Application Priority Data
Apr. 28, 2000 (NL) NL 1015061

(51) Int. Cl. H04N 7/167

(52) U.S. Cl. 725/31; 380/201; 380/210

(57) ABSTRACT

The invention relates to a distribution system for film or sound information comprising an information source, at least one information transport channel and an information receiver. The information source is a digital database a source computer. The at least one information transport channel is equipped for transmitting digital information, is part of the Internet and comprises a host computer that can be linked with the source computer. The host computer comprises a converter for converting digital information of a first kind originating from the source computer into information of the second kind, and the information receiver is a data processing machine that may be equipped for converting information of the second kind into information of the first kind. To the data processing machine a reproduction unit for image or sound can be connected.

The invention relates to a distribution system for film or sound information comprising an information source, at least one information transport channel and an information receiver.

Such a distribution system is known in practice. Where such a distribution system for sound information is concerned, it is called radio distribution or wire broadcasting. With respect to film information, a system is known that uses decoders to allow a user to view selected films in his own surroundings. In this latter case, the film information may be distributed both via the ether and via the cable. A feature of this latter system is that the desired film information is selected or ordered by a user and that it has to be paid for.

EP-A-0 691 787 relates to an apparatus and method offering controlled reception of broadcast signals. On the basis of an access-control signal transmitted along with the broadcast signals, the receiver of the broadcast signals is able to process and reproduce said broadcast signals.

EP-A-0 763 936 relates to a digital broadcasting system for audio and/or video information according to the preamble of claim 1. This known broadcasting system is secured against illegal reception and reproduction. The system comprises to that end a digital database on a source computer, at least one information transport channel equipped for transmitting digital information, an information receiver, and a converter for converting (non-encoded) digital information of a first kind originating from the source computer into (encoded) information of the second kind, whereby the information receiver is a data processing machine which is equipped for converting information of the second kind back into information of the first kind, and wherein a reproduction unit for image or sound can be connected to the data processing machine, and wherein during use, the converter divides the digital information of the first kind into blocks, and inserts scrambling information between the blocks for the formation of the information of the second kind.

For the distribution of sound information, a system wherein a user orders a desired sound fragment for which he pays and which he subsequently receives, is not yet known. It is therefore a first objective of the invention to provide a distribution system for sound information, which is coupled with a pay function, allowing a user of the system to select and obtain previously determined information for reproduction. However, the invention is not limited to this objective but may also relate to the distribution of film information. A further objective of the invention is to make the desired sound or film information available to the user at a moment in time determined by the user. Further objectives and advantages of the invention will be elucidated hereinbelow.

In a first aspect of the invention, the distribution system is characterized in that it is part of the Internet and comprises a host computer that can be linked with the source computer, wherein the host computer comprises the converter, which—during use—adds to the fist block a head containing at least address information relating to the data processing machine, wherein the head comprises status information relating to

a) the approved number of occasions the information of the second kind is converted into information of the first kind; and/or

b) the length of time during which the information of the second kind is authorized to be converted into information of the first kind; and/or

c) the authorization for making a copy, and wherein the data processing machine is embodied with a reconstruction member for converting information of the second kind into information of the first kind, the activity of the reconstruction member thereby depending on at least the status information.

It may be noted that it is also possible that the host computer coincides with the source computer. It is also conceivable to completely leave out a separate source computer, and that on the host computer only encoded information, i.e. information of the second kind, is present.

This distribution system proposed in accordance with the invention makes it possible to transmit on request encoded information of films or music or sound fragments, to a data processing machine, usually a personal computer. On application, the user may then pay, for example, by means of a credit card account, or he may pay for the service by means of a prepaid account kept by the host computer and which is coupled to the respective data processing machine or user.

Where sound fragments or music is concerned, it is advantageous for the database information of the first kind to be comprised of MP3 music files. By means of such music files it is possible to provide a user with music of high quality regarding recording technique, comparable with the reproduction quality of the known compact disc.

Securing said source information from unauthorized use and illegal copying, i.e. use for which no appropriate payment has been made, is effectuated such that the head comprises status information relating to

a) the approved number of occasions the information of the second kind is converted into information of the first kind; and/or

b) the length of time during which the information of the second kind was authorized to be converted into information of the first kind; and/or

c) the authorization for making a copy.

In this manner it is possible to employ different tariffs, for example, for listening once to a certain piece of music or viewing a certain film or film fragment, or listening or viewing repeatedly or a predetermined number of times. It is also possible to link payment to a limited length of time, or as the case may be, to an unlimited length of time, wherein payment is not related to the number of times the file with the information of the second kind, and received by means of the data processing machine, has been used. Finally, payment may be linked to the possibility of using said information, after its conversion into information of the first kind for copying it, for example, onto a writable compact disc.

To effectively secure the information traffic, and in particular to secure the payment of fees relevant to the use that will be made of the information, it is desirable for the information of the second kind to be provided with additional security. This may preferably be realized by incorporating a checksum in the head. By this means it is possible to visualize a file containing information of the second kind being processed without authorization, because the checksum will have an incorrect value.

In another aspect of this security function, it is desirable for the head to comprise a check code identifying the data processing machine. By means of such a provision, the information transmitted is linked to a particular data processing machine so that copying and playing on another machine or by another user can be rendered impossible.

One thing and another is effectively realizable by having the data processing machine embodied with a reconstruction member for converting information of the second kind into information of the first kind, the activity of the reconstruction member depending on not only the status information but also the checksum and/or the check code. The reconstruction member is then preferably a digital filter that the playback device can obtain from the host computer. This digital filter then forms, as it were, a player by means of which the respective encoded sound information or film information (information of the second kind) can be reconstructed. Said player may be made available to a user or data processing device without security because the actual information, i.e. the sound fragments or image fragments themselves are encoded.

However, in a further embodiment of the distribution system according to the invention it is preferred that after placement and initial use, the reconstruction member retain information on the data processing machine for the identification of the data processing machine. This provides additional security because the reconstruction member, after it is linked in this manner with the data processing machine, only authorizes reconstruction of encoded information addressed to said data processing machine. As already explained above, the latter ensues from the check code incorporated in the head of the information.

The distribution system is preferably further embodied such that the reconstruction member comprises an arithmetic unit to determine a current checksum pertaining to the information of the second kind, and a comparator for comparing said current checksum with the checksum present in the head of the information. In this way the checksum information can be used effectively.

In a completely different aspect of the invention, the distribution system is characterized in that the reconstruction member forms part of the information of the second kind. The reconstruction member is then preferably incorporated in the head of the information of the second kind.

This greatly improves the integrity and resistance to undesirable manipulation of the system and the sound and/or image information made available. By this means a reconstruction member specifically adjusted to this information is provided for every separate fragment.

It will be clear from the foregoing that the invention is also embodied in the host computer and data processing apparatus that are part of the distribution system, and additionally in the information signal with information of the second kind as formed according to the invention. The claims are accordingly directed at these categories.

In the following, the invention will be further elucidated with reference to a non-limiting exemplary embodiment according to which music files can be made available to users. In this example, to which the invention is not limited, music files are made available on request and after payment via Internet. To this end the music fragments are obtained from a source computer comprising a central databank in which music files are recorded, classified according to country and/or performing artists and/or music style. This central file may be approached via an Internet site. This Internet site protects the central data file, but makes the music files in it available to users via encoded access. If the users meet certain conditions, the coded music files can be decoded, such that they may be listened to in the normal way. To this end the music files may be retrieved via this Internet website. On the site, new users are required to make known their name, E-mail address and password. The user thus identified is then able via a search program to search the desired product on the website. Having selected a particular music fragment, the user in the present example has the option of

a) playing the respective music fragment once or more than once;

b) playing within a predetermined time period;

c) recording the music fragment by burning a compact disc or the like.

The price the user has to pay for one of the above alternatives depends on the respective alternative. Payment is made by credit card or by making use of a prepaid account kept up to date on the website for the respective user. In order to be able to reconstruct the encoded information to the original information, the user links a reconstruction device or player to be obtained from the website to his personal computer. Alternatively, such a player may each time be transmitted together with a retrieved music file. Each time a music file is reproduced, the reconstruction device checks whether this is authorized by carrying out a check on data recorded in the head of information of the second kind, received by the personal computer. This head contains status information relating to the number of times or the length of time it is allowed to listen to, or make a copy of the respective music file, and further information relating to the data processing machine to which the information is transmitted. The head further contains a checksum, calculated on the basis of information of the second kind recorded in the respective music fragment. If the results of all the checks are positive, the reconstruction device can convert the (encoded) information of the second kind into the (original) information of the first kind, to allow suitable reproduction by means of the known reproduction apparatus.

The invention provides a completely new distribution system providing new ways for the commercialization of music and film. An essential element of the invention is that the original and digitized files are protected against unauthorized use. The invention provides a system, which is however, not completely resistant to cracking of the encoding being used to obtain the information of the second kind. However, an important advantage of the invention is that each separate fragment is encoded individually and that cracking the relevant code only provides access to the respective music fragment or image fragment without disclosing all the original information of the first kind present in the database. The invention uses a reconstruction device or player that is made available freely, and which comprises means for carrying out the necessary checks regarding status, identity of the data processing machine, and checksum, as explained above.

The above description is expressly to be understood as an exemplary embodiment that does not give a limitative description of the invention, but rather serves as elucidation, and therefore does not limit the protective scope derived from the appended claims.

What is claimed is:

1. A distribution system for film or sound information comprising a digital database on a source computer, at least one information transport channel equipped for transmitting digital information, an information receiver, and a converter for converting digital information of a first kind originating from the source computer into information of a second kind, wherein the information receiver is a data processing machine which is equipped for converting information of the second kind into information of the first kind, and wherein a reproduction unit for image or sound is connectable to the data processing machine, and wherein during use, the converter divides the digital information of the first kind into blocks, and inserts scrambling information between the blocks for the formation of the information of the second kind, wherein the system is part of the Internet and comprises a host computer that can be linked with the source computer, wherein the host computer comprises the converter, which during use adds to the first block a header containing at least address information relating to the data processing machine, wherein the header comprises status information relating to one or more of:
a) an approved number of occasions the information of the second kind is converted into information of the first kind;
b) a length of time during which the information of the second kind is authorized to be converted into information of the first kind; and
c) an authorization for making a copy;
wherein the data processing machine is embodied with a reconstruction member for converting information of the second kind into information of the first kind, the activity of the reconstruction member thereby depending on at least the status information.

2. A distribution system according to claim 1, wherein the database is comprised of MP3 music files.

3. A distribution system according to claim 1, wherein the header comprises a checksum.

4. A distribution system according to claim 3, wherein the header comprises a check code identifying the data processing machine.

5. A distribution system according to claim 4, wherein activity of the reconstruction member depends on one or both of the checksum and the check code.

6. A distribution system according to claim 5, wherein the reconstruction member is a digital filter that the playback device can obtain from the host computer.

7. A distribution system according to claim 6, wherein after placement and initial use, the reconstruction member retains information on the data processing machine for the identification of the data processing machine.

8. A distribution system according to claim 1, wherein the reconstruction member comprises an arithmetic unit to determine a current checksum pertaining to the information of the second kind, and a comparator for comparing said current checksum with the checksum present in the header of the information.

9. A distribution system according to claim 2, wherein the reconstruction member forms part of the information of the second kind.

10. A distribution system according to claim 9, wherein the reconstruction member is incorporated in the header of the information of the second kind.

11. A host computer having a converter for converting information of a first kind into information of a second kind, wherein during use the converter divides the digital information of the first kind into blocks, and inserts scrambling information between the blocks, wherein the converter adds to the first block a header containing at least address information relating to the information receiver, for the information of the information of the second kind, which header comprises status information relating to one or more of:
a) an approved number of occasions the information of the second kind is converted into information of the first kind;
b) a length of time during which the information of the second kind is authorized to be converted into information of the first kind; and
c) an authorization for making a copy.

12. A host computer according to claim 11, wherein the header comprises a checksum.

13. A host computer according to claim 12, wherein the header comprises a check code identifying an information receiver.

14. An information signal embodied by blocks of digital information and scrambling information inserted between the blocks, comprising a header containing address information placed before the first block which identifies an information receiver.

15. An information signal according to claim 14, wherein the header comprises status information relating to one or more of
a) an approved number of occasions the information of a second kind is converted into information of the first kind;
b) a length of time during which the information of the second kind was authorized to be converted into information of the first kind, and
c) an authorization for making a copy.

16. An information signal according to claim 15, wherein the header comprises a checksum.

17. An information signal according to claim 6, wherein the header comprises a check code identifying the information receiver.
